(19) United States
(12) Patent Application Publication
(10) Pub. No.: US 2021/0377310 A1
(43) Pub. Date: Dec. 2, 2021

(54) METHOD, SYSTEM, APPARATUS AND PROGRAM FOR SECURE DISTRIBUTED DATA MANAGEMENT USING COLLABORATIVE ARTIFICIAL INTELLIGENCE

(71) Applicant: Shoptaki Inc., Staten Island, NY (US)

(72) Inventors: Asnee Fernando, Staten Island, NY (US); Kishan Teli, Staten Island, NY (US); Raveena Mehta, Staten Island, NY (US); Dhariya Parikh, Staten Island, NY (US)

(73) Assignee: Shoptaki Inc., Staten Island, NY (US)

(21) Appl. No.: 17/333,684

(22) Filed: May 28, 2021

Related U.S. Application Data
(60) Provisional application No. 63/032,326, filed on May 29, 2020.

(51) Int. Cl. H04L 29/06; H04L 12/18; G06N 20/00; G06F 16/901

(52) U.S. Cl. CPC H04L 63/18; H04L 63/0861; H04L 63/0236; H04L 63/101; G06F 16/9024; H04L 63/061; H04L 63/306; H04L 12/1886; G06N 20/00; H04L 63/105

(57) ABSTRACT

A method, system, apparatus, and program for managing data with distributed management system and distributed artificial intelligence (AI) that includes a plurality of nodes in a hyper connected network and a plurality of AI agents and that utilizes SmartIDs wherein a central server uses AI to delegate tasks to master AIs associated with said nodes and the master AIs direct packets of information associated with smart IDs to correct destinations within the network.

### CROSS REFERENCE TO RELATED APPLICATION

This application claims priority from provisional application 63/032,326 filed on May 29, 2020, the contents of which are incorporated herein in their entirety.

### BACKGROUND OF THE INVENTION

### Field of the Invention

The present invention relates to a method, system, apparatus, and program for managing data securely with distributed collaborative artificial intelligence (AI).

### Related Art

A blockchain is a growing list of records that are linked together using cryptographic techniques. This technology provides the infrastructure of cryptocurrencies. It is a decentralized, borderless distributed ledger that promises transparency and immutability of the transactions it records. Blockchain technology allows the transition from trust-based systems, where the identity of the parties involved in a transaction needs to be constantly verified, to truth-based systems, where the key information is recorded in the code itself. However, the conventional blockchain has a few drawbacks, some of which are explained below.

Using blockchain has a very high entry barrier for ordinary people because it is hard to understand and hard to use, especially in its raw form. The conventional blockchain is still primarily for service providers and industry-level users.

In many industries, data is completely fragmented while being siloed as well as growing in complexity; this increases the risk of data breaches of sensitive data such as social security numbers or medical records, which should be authorized by the user to send across different organizations. Hence, there should be a direct linkage between the verified identity of the user and the data that is ultimately presented to the user. Data should be identity-driven.

The KYC (know your customer) solutions are disconnected from reality. Conventional KYC solutions provide a range of features including ID tokenization, social media integration, and watchlist screening. The main problem with these digital identity services is that they are disconnected from real-life identities. Maintaining digital identities will only make sense if there is a bridge to real-world identities.

While blockchain offers the benefits of an open ecosystem, it can be vulnerable to human error.

Blockchain uses Elliptical Curve Digital Signature Algorithm (ECDSA) to sign digital signatures. Furthermore it uses SHA-256 cryptography standard to hash the blockchain. Quantum computers can be able to reverse the hash value process and derive the public key

The conventional blockchain has increased transaction costs since trading on a blockchain system would be slow and mistakes can be irreversible, leading to huge losses.

In addition, because of their inherently distributed and peer-to-peer nature, blockchain-based—transactions can only be completed when all parties update their respective ledgers—a process that might take hours. As ledgers grow, blockchain-based transactions can bog down. Thus, the conventional blockchain would face performance issues.

Blockchains depend upon enough parties using the same implementation of the technology to deliver—a classic example of a network effect. However, it is unclear whether any particular blockchain solution (other than Bitcoin® itself) will ever be able to reach this threshold.

Further, users do not have control or oversight of where their data is going; for example, certain regulatory information would have different formats of data that might be unstructured or different types of databases, which can be overwhelming and increase the cost of labor and storage capacity.

There exists, therefore, a need for a novel method and system for managing data with distributed artificial intelligence that overcomes the above-noted and other drawbacks of the existing methods.

### SUMMARY OF THE INVENTION

The following presents a simplified summary in order to provide a basic understanding of some aspects described herein. This summary is not an extensive overview of the claimed subject matter. It is intended to neither identify key or critical elements of the claimed subject matter nor delineate the scope thereof. Its sole purpose is to present some concepts in a simplified form as a prelude to the more detailed description that is presented later.

The invention will provide a Smartchain network that is secured through the concept of tunnelling and post quantum cryptography. This will prevent accessing encrypted data by the use of Quantum computing.

The present invention can greatly benefit society as a whole. The present invention can unify and organize the Internet as such where a universal identification program can be implemented to act as a “Swiss Pocket Army knife” for data management; such examples include acting as a next digital Social Security Number or data collection authentication (who has that data and why).

Unlike standard blockchain methodologies, in an embodiment, data can be pulled from multiple aggregators and executed in packets instead of blocks. This allows various avenues of data such as voice, video, transpatial data, etc. The packets will then be decrypted and assembled in a way defined in the corresponding application protocol, such as HTTP 3.0. Standard blockchain methodology is immutable, while theoretically desirable, realistically in certain situations, transactions would have to be reserved or alter data, and the overall system needs to be dynamic and fluid not rigid. The collaborative AI agents will keep a record of changes and be the ones that might deal with altering of data for the benefits of the parties transmitting the data.

The present invention provides a Hyper connected network for passing information between users comprising inter connected nodes and central server using AI to delegate tasks to master AIs associated with said nodes wherein said master AIs direct packets of information associated with smart IDs to correct destinations within the network wherein the smart ID includes relevant and valid data belonging to each individual using the network, and wherein the AI associated with a node strips the smart ID of any information that is not relevant to its destination.

This invention can comprise a hyperconnected ecosystem that connects to different ecosystems and systems; the pre-existing infrastructure that the organization has can be interconnected, but at the same time for security purposes be separated. Collaborative AI agents can be intertwined with the entire infrastructure from improving to optimizing the system, to analyzing and autonomizing tasks for different industries such as Know Your Customer (KYC), Anti-money laundering (AML), or Optimization financials.

The financial sector can yield transparency and privacy efficiencies in this innovation. The industry, as a whole, can benefit from a reduction in fraud and Anti-Money Laundering to ensure that standard onboarding practices are more competent and cost-effective to the financial organization. Government organizations experience huge disconnects in data. With the developed core technology such organizations will ultimately be able to interconnect certain data to streamline processes, with proper implementation, while maintaining a degree of separation for security reasons.

The present invention can be considered a network that connects different types of infrastructures, databases, and systems, while transferring all that data securely and fast. The AI agents can help maintain the entire system that does not need the typical heavy resources, which a blockchain consensus system would do since this has to be highly flexible for all types of use cases.

The components of the present invention can deal with certain types of data including an individual's identity, such as social security, driver's license, passport ID, bank account numbers, etc. The component which gives access to all this data is SmartID, which connects all the data related to the user and can be used for the authentication purpose as well. The present invention will use users' unique SmartIDs for login or identification purposes, and the system they wish to access will recognize the user and thus grant them access. The user can tell the SmartID what information can be accessed based on the system that sends the request by providing rights to that specific system to access the data through SmartID. For example a banking system does not need to access one's medical records and so such information will not be shared. Hence, the SmartID will recognize the platform's purpose for banking, and that will trigger the medical ID information on the SmartID to be made unavailable. SmartId can act like a universal identifier that links the user's information with the respective systems that might need that information. Likewise, another site might not need passport information, so that piece will be made unavailable. Platforms will only be granted access to identifying information that is relevant to the usage of that platform. Once a user is identified and granted access, only information pertaining to the user will be accessed, as is the current case when accessing any platform. The SmartID will prevent any hacking into information that is not relevant to the user, adding an extra layer of protection that may or may not be available in all platforms. Once the user has completed his/her access to the platform, the SmartID removes its identifying information from the platform using a state of the art AI system designed for the sole purpose of removing redundant information and ensuring that the next user of the system cannot inadvertently capture the previous user's sensitive information, yet another added layer of security that the SmartID provides. The SmartID goes beyond application level, as in the individual themselves is the SmartID with the use of biometrics. For example if a user was to go to a store without a phone or a wallet, they would be able to access their info and data thru the cloud using biometrics. This can be used in a wide range of industries and use cases.

In a traditional blockchain, transactions that occur create blocks of data that are then verified as accurate and appended to chains. These chains are then made available (copied) to any system that wishes to view their information. Having identical information present in numerous places makes them extremely difficult to hack, thus makes blockchain usage attractive. The present invention takes this blockchain concept much further. As the usage of blockchains continues to increase, the enormous collection of data will become unmanageable. Much of the data is likely redundant. For example, many transactions may involve the entering of a social security number, a driver's license, date of birth, etc. Multiple systems could be concurrently trying to review data and gauge its validity. This can have the effect of delaying many transactions, in some cases urgent ones, from occurring swiftly, leading to serious consequences. The present invention aims to manage the volume of data, reduce its redundancy, verify its validity and quicken the pace of transactions. A key aspect of this endeavor is the usage of a SmartID which will encapsulate all relevant and valid data belonging to each individual. As that individual goes from system to system to perform a transaction, his or her information will not need to be entered multiple times and stored in multiple databases. The system will accept SmartID's and allow the transaction to be executed with minimal time delay.

The idea of SmartID is to validate and to determine a real person's/business by a set level of rating in various domains such as social, financial, and others. Hence it is required to have the network of the present invention to be adaptable to addition of attributes to SmartID. The addition of such attributes may be static or dynamic. For example, in our case, attributes can be any personal information such as bank account details, phone number, etc. These attributes can be subjected to change in the future, which thus, determines whether they are static or dynamic. For example, a person's contact number can change in the future, thus, making it a dynamic attribute.

The system can comprise collaborative AI agents. Each AI Agent can perform different tasks such as optimizing the infrastructure, cleaning data, KYC, and many other purposes based on the use cases. These AI agents either use pre-trained models (for example, the text summarization agent uses pre-trained model GPT-2 to transform the input text and generate the summary) or are trained dynamically during the task to achieve specific goals. This collaboration can ensure no single point of failure and having this collaboration to solve a problem. The SmartID component is to not only ensure the legitimacy of a user entity but to also let users have control of certain data that goes across different ecosystems. For example, a user could eliminate the hassle of contacting administration to send medical records through the click of a button. The additional benefit is not having missing information.

The present invention relates to the core technology for a dynamic-fluid distributed system that can deal with the hyperconnected ecosystem (similar to a mesh network). The use of different AI agents can make the network fully autonomous of the processes and tasks. The core technology should be able to connect with other chains/systems and can be hyperconnected in one ecosystem. This will be considered a new type of smart distributed systems that potentially lead to data singularity. Data singularity can provide a tremendous opportunity for companies ready to step up and take advantage of this new model. Imagine being able to easily connect data from your supply chain to market analysis data and using it to make strategic decisions about product development.

Convergence of data has tremendous and broad implications for innovation in business. Tech-based companies working on creating smart electronic products can leverage the potential to enable informed, real-time, and strategic decisions to drive business success. The decisions being facilitated range widely.

Unlike blockchains, organizations and use cases can have different types of policies, compliance/regulations, and security concerns, while data on the Internet is unstructured and fragmented all over the place. This hyperconnected ecosystem can connect different ecosystems so data can be isolated and secured but at the same time certain data will be shared and streamlined while AI agents are automating processes, optimizing infrastructure, indexing and classifying data, and much more. While the system is hyperconnected, AI agents can verify whether the data being used by the user is for legal purposes or not, by tracking the network data path used by the AI agent for that particular task across ecosystems to alert organizations anonymously or transparently for cases such as money laundering, policies and compliance issues. This can be applied to the medical sector where you can track rate of infection in real time or be implemented in many other industries where you will need to track certain data across organizations or ecosystems.

In one embodiment, there is provided a distributed data management system, comprising: a central global server; wherein the central global server comprises a central network and a plurality of distributed nodes, wherein the central global server can communicate with a plurality of ecosystems, wherein the central network is configured to store information of transactions between the plurality of ecosystems and the central global server, wherein each of the plurality of distributed nodes comprises: a plurality of artificial intelligence agents (AI agents), a transaction engine, a network connector for peer-to-peer, and a graph database, wherein each of the plurality of distributed nodes directly or indirectly communicates with the central network.

In another embodiment, the plurality of AI agents comprises at least one of a network load optimizer, a financial risk analyzer, a fraud detector, a social presence validator, a non-social presence validator, an all compliance executor, a transaction behavior predictor, a structured data analyst, and/or an unstructured data analyst.

In a preferred embodiment, at least one of the plurality of distributed nodes is configured to communicate with an ecosystem and to handshake with a new ecosystem.

In an alternative embodiment, the plurality of distributed nodes are configured to directly communicate with each other.

### BRIEF DESCRIPTION OF THE DRAWINGS

The features and advantages of the present invention will be more readily understood from a detailed description of the exemplary embodiments taken in conjunction with the following figures:

FIG. 1A is a diagram of an exemplary hybrid network of the invention according to one embodiment.

FIG. 1B is a diagram of an inter-cloud arrangement.

FIG. 2 is a diagram of an exemplary Distributed Network System according to one embodiment.

FIG. 3 is a diagram of exemplary clusters and training execution of the invention according to one embodiment.

FIG. 4 is a diagram of an exemplary tensor GPUs interface of the invention according to one embodiment.

FIG. 5 is a diagram of an exemplary Data Parallelism of the invention according to one embodiment.

FIG. 6 is a diagram of an exemplary core technology of the invention according to one embodiment.

FIG. 7 is the diagram of Shoptaki data transfer communication.

FIG. 8 is a diagram representing the architecture of Smartdive technology present on the Smartchain network.

FIG. 9 is a diagram representing interactions between several components within a collaborative AI agent system.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

The present disclosure relates to the advanced version of the blockchain (or Smartchain®) and to a hybrid of the distributed and decentralized networks within a mesh network, where each node can be treated as a master node when that node distributes the data information in a private mesh network. The classic hyper fast ledgers can be decentralized and get validated on each node. Thus, transactions will go through these different databases/ledgers, and get verified and processed very fast. The invention can be a core framework which could cover multiple domains in the corporate sector. Financial, supply chain, medical and other domains can also be the part of the invention core technology.

The core system of the present disclosure can be a combination of infrastructure as a service, platform as a service, and software as a service. With the present disclosure, users can build on the technology whatever use case they want. For example, the invention can be a framework such as Ethereum®, on which developers can build whatever use case they want.

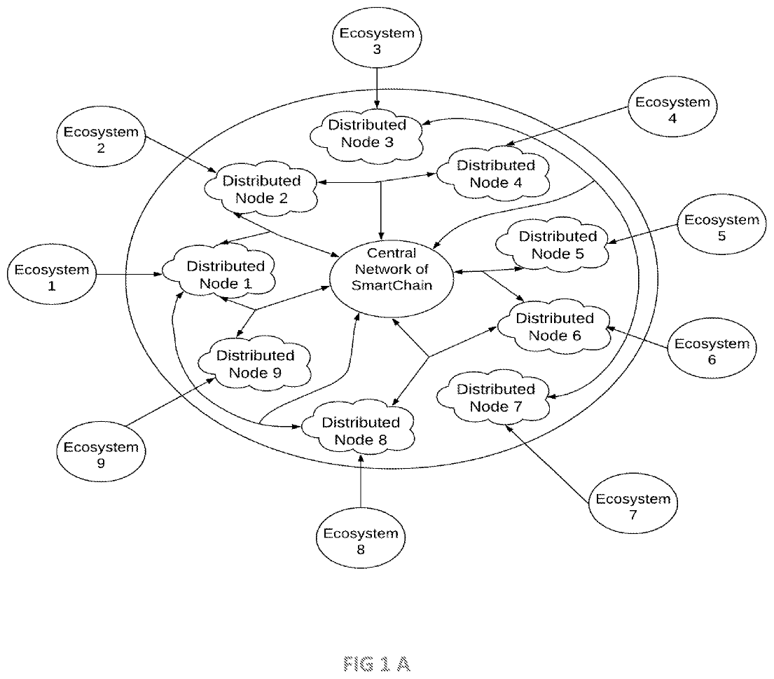

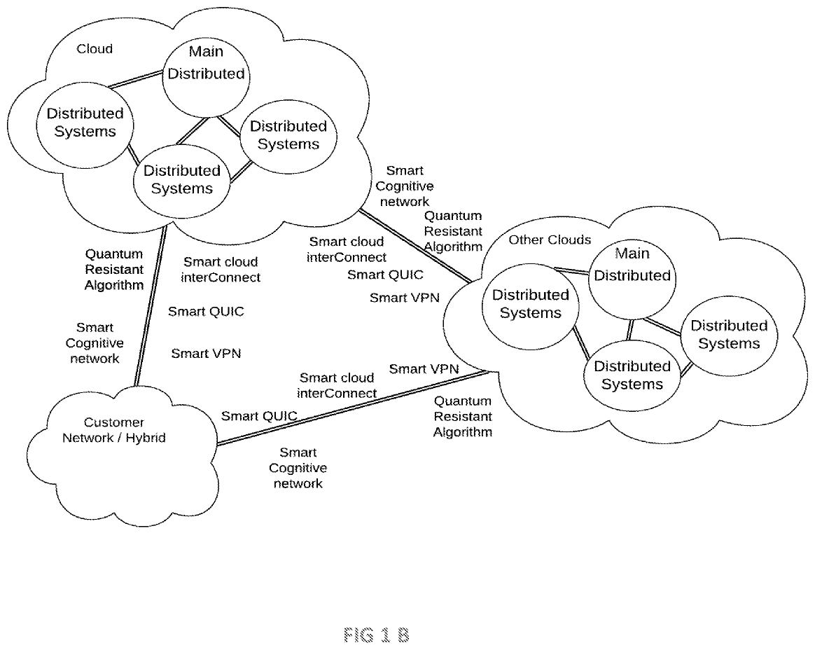

In one embodiment, the invention is a new generation of technology for the transaction system. In this embodiment, the invention is a core technology which will be a hybrid of distributed and decentralized technology. The whole system can be a mesh private network of many ecosystems and can incorporate any other ecosystem. See, e.g., FIG. 1. Processes in the whole system can be automated by AI Agents. For example, a use case for financial transactions on top of the core technology can be implemented. In addition, the system can be highly dynamic to be able to work on old, new and/or future infrastructures since some clients might have for example old systems or old data structure formats. The system can connect with other chains, but when it comes to the present invention, it can be hyperconnected to form one big hyper connected ecosystem. The invention can be a hybrid of distributed and decentralized elements with, for example, master nodes taking on important and security-related tasks that the public cannot take due to the risk of compromise. Within individual self-contained ecosystems, clients can add or build DAAPs (Data as a Platform) or AI (artificial intelligence) agents for whatever reason they need to. One of the advantages of the present disclosure is that all the data can be streamlined within the organization, for example as an organized internet or intranet, instead of organizations having separate departments that are fragments and do not communicate with each other.

Referring to FIG. 1, there is a hybrid network of the invention according to one embodiment. The present invention comprises a central global server 103 (super master nodes) that controls the other ecosystems. The central global server 103 comprises a Central Network, which stores metadata, SmartID AI models, etc., and at least one distributed node (Distributed Nodes 1-9). When developers build their own use case or ecosystem, it can handshake with the central server 103 to bridge the other ecosystems. Developers' own use case or ecosystem can have their own policies and their own architecture in their ecosystem. While developers can keep their data private, certain data, such as SmartID, or other types of data can be shared across the overall hyper connected ecosystem.

Again referring to FIG. 1, distributed nodes can be configured to communicate with respective ecosystems. Some distributed nodes can be configured to directly communicate with each other. For example, Distributed Node 1 can be configured to directly communicate with Distributed Nodes 2 and 8. All distributed nodes can be configured to directly or indirectly communicate with the Central Network. Each ecosystem or individual SmartID can have their own Distributed Node Networks. These networks can make transactions to each other, where each transaction can be analyzed by automated APIs of AI agents that can be done on their nodes as well. Preferably, whenever a transaction occurs, each node connected into the mesh network gets updated with that transaction and a ledger will be maintained on each node.

The central global server 103 (super master nodes) connects the other ecosystems and can be the bridge among different industries. The central network of the central global server 103 can store all the rules for the AI Agents that govern the network, SmartIDs, and metadata related to all users. The metadata can contain all necessary details such as rating scores, services used, data sharing policies, data sharing preferences of Smarts, any info related to data security, any configurable parameters, AI models running in distributed nodes, etc. The central global server 103 can be configured not to keep any sensitive data of the SmartIDs. Private data can be only with the authorized ecosystem which will be considered the custodians.

When developers build their own use case/ecosystem, it will handshake with the central system because it will be a hyperconnected ecosystem, but the developers can have their own policies and their own architecture in their own ecosystem, while they keep private certain data such as SmartID that tends to be shared across the overall hyperconnected ecosystem, and they can share other certain types of data as well.

Data sharing can be requested by an ecosystem from another ecosystem through the global server 103. The coordination of such sharing can be done by the policies and preferences set by ecosystems. The actual data that is shared between ecosystems (e.g., private data of SmartIDs) need not route through a server.

The invention has the possibility of seamless addition of connections to new ecosystems and seamless removal of connection from an existing ecosystem, to the central global server 103.

Each ecosystem or individual user can have their own Distributed Node Networks, these networks are capable of making transactions to each other, where each transaction can be analyzed by automated APIs of AI agents that can be done on their nodes as well.

Depending on the use case or ecosystem, the invention can have one or more master nodes and one or more secondary nodes, wherein the master nodes would be the entire ecosystem that will have rules of the AI agents and other policies, and wherein the secondary nodes can be configured to perform non-vital actions based on use cases. In theory, the more ecosystems that are built, the stronger the network and less of a burden to the system. For example, each financial transaction can be updated to the centralized network. This hybrid approach is one step ahead of the Blockchain Architecture. It can be considered a hybrid of centralized or decentralized systems depending on the use case and ecosystem. Another example can be an identity—different industries mean multiple identities, which can lead to fraud and falsified identity.

When it comes to security, the quantum cryptographic encryption can be used for the data encryption and can provide the data in that format where this will be near non-decryptable due to the changing behavior of the encryption level at certain processes.

The framework of the invention can partially be open source, but certain things, for example the financial transaction layer, can be configured not to be altered.

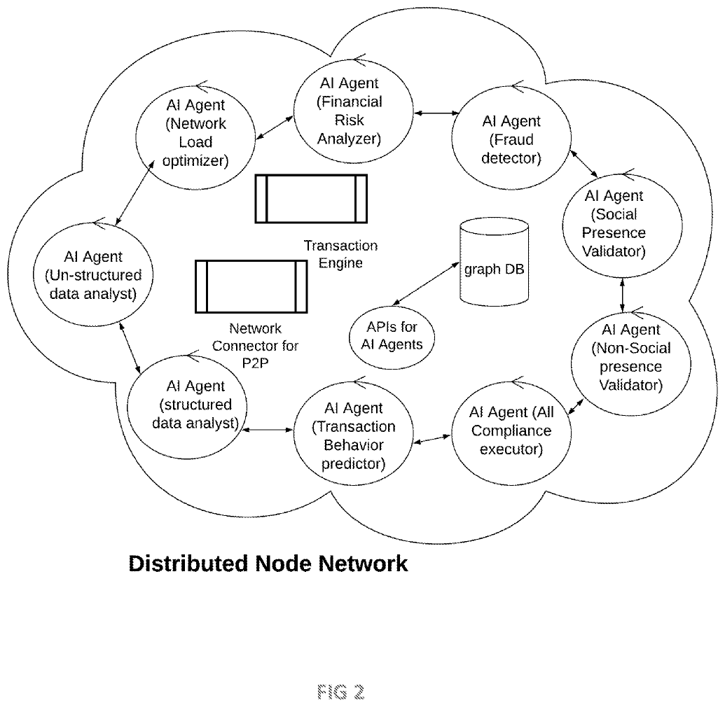

Referring to FIG. 1B, there is a diagram of Intercloud setup. Inside a cloud there will be the main or the central distributed system and distributed systems interlink to each other like a Mesh Topology. Each distributed system whether inside the cloud or connected via Smart Cloud InterConnect, will go to the Smartchain network. Smartchain network opens a secure tunnel with quantum-resistant encryption and will send the data through Smart QUIC. Routing as well as other key factors that have an influence on network performance will be optimized by AI agent(s), as introduced in the following text (FIG. 2).

Referring to FIG. 2, there is a diagram of an exemplary Distributed Network System according to one embodiment. Each of the Distributed Nodes of the central global server 103 can comprise a plurality of AI agents. AI agents can act as a network optimizer (such as load balancer or routing optimizer), a financial risk analyzer, a fraud detector, a social presence validator, a non-social presence validator, an all compliance executor, a transaction behavior predictor, a structured data analyst, or an unstructured data analyst. A distributed node can be an infrastructure for developing AI agents. The AI agents can guide the distributed nodes to make predictions at an optimized level, and they are validating each and every aspect that they could reach to the completion of the transaction. An AI agent can identify patterns of previous behavior over a period of time and when a pattern is broken, it would be flagged as anomalous behavior. For example, predictions can be derived from ascending, descending, and flat patterns.

Preferably, each node can have its own AI agents and Graph Database with the AI Agent's APIs (application programming interface).

Preferably, there may be some engines to perform some predefined processes on incoming and outgoing data.

The invention can comprise a Transaction Engine. The Transaction Engine is the core engine of the node which will be directly used by the connected ecosystem to take the connected ecosystem's request and provide acknowledgements. The Transaction Engine can parse structured/unstructured data into a graph database or different database. The data can be taken care of by the AI agents accordingly.

The invention can comprise a Network Connector for P2P. The Network Connector for P2P is for establishing and maintaining P2P connections between peers. The quantum resistance security will be defined on this channel. A multilayered quantum-resistant encryption can be implemented to secure the network. For example, asymmetric cryptography such as the quantum-safe RLWE-KEX and RLWE-SIG, as well as symmetric cryptography such as AES-256, and/or Data Obfuscation Time/Rule-based heartbeat can be used.

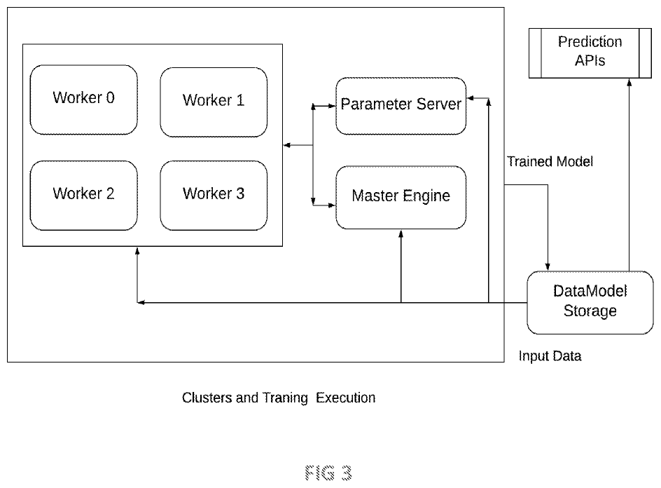

Referring to FIG. 3, there is a diagram of clusters and training execution of the invention according to one embodiment. This involves a plurality of workers (Workers 0-3), a Parameter Server, a Master Engine, a Data/Model Storage and a Prediction APIs. The Data/Model Storage can supply data to the plurality of workers. The invention can have a Cluster-Architecture. In one embodiment, the invention uses Master-Worker services. The Master Engine can take on tasks such as opening the session and using it to run knowledge graphs. The Master Engine coordinates the computations across tasks, relying on the worker service to actually execute computations on other tasks and get their results. All the computations can be performed in parallel on all the worker engines. The data can be fed to the engines in mini batches

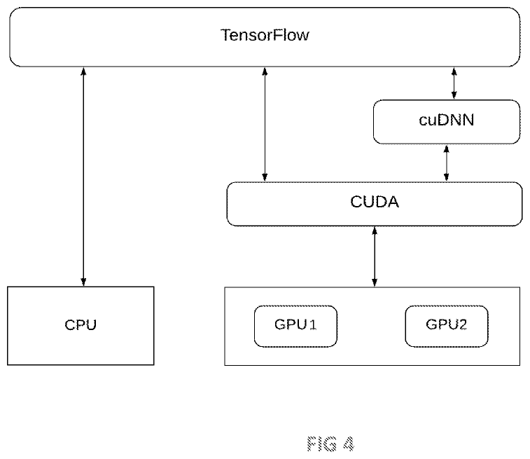

Referring to FIG. 4, there is an exemplary tensor GPUs interface of the invention according to one embodiment. Preferably, GPU cards with NVIDIA Compute Capability greater than or equal to 3.0 can be used to run TensorFlow on multiple GPU cards.

Open source software libraries such as TensorFlow, Pytorch are used by developers to design, build, and train deep learning models.

Parallel Computing and Deep Neural Network can be implemented in the invention. Parallel Computing allows the invention to use Parallel Computing enabled GPUs for all sorts of computations, while Deep Neural Network is a GPU-accelerated library of primitives for DNNs. It provides optimized implementations of common DNN computations such as activation layers, normalization, forward and backward convolutions and pooling.

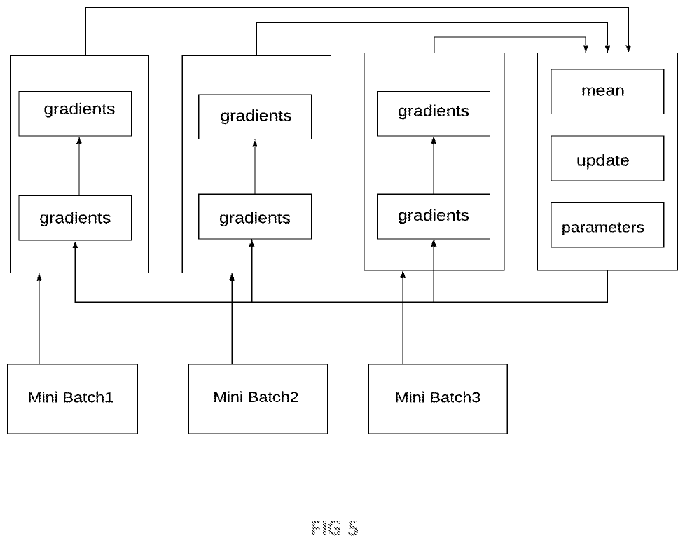

Referring to FIG. 5, there is a diagram showing an exemplary Data Parallelism of the invention according to one embodiment. Data Parallelism is a way to parallelize the training of a neural network to replicate it on each device, run a training step simultaneously on all replicas using a different mini-batch for each and then aggregate the gradients to update the model parameters. Here, data is divided into several mini batches and fed into neural networks which are running on different systems. Then the aggregator gets all the gradients, computes an average, and updates model parameters.

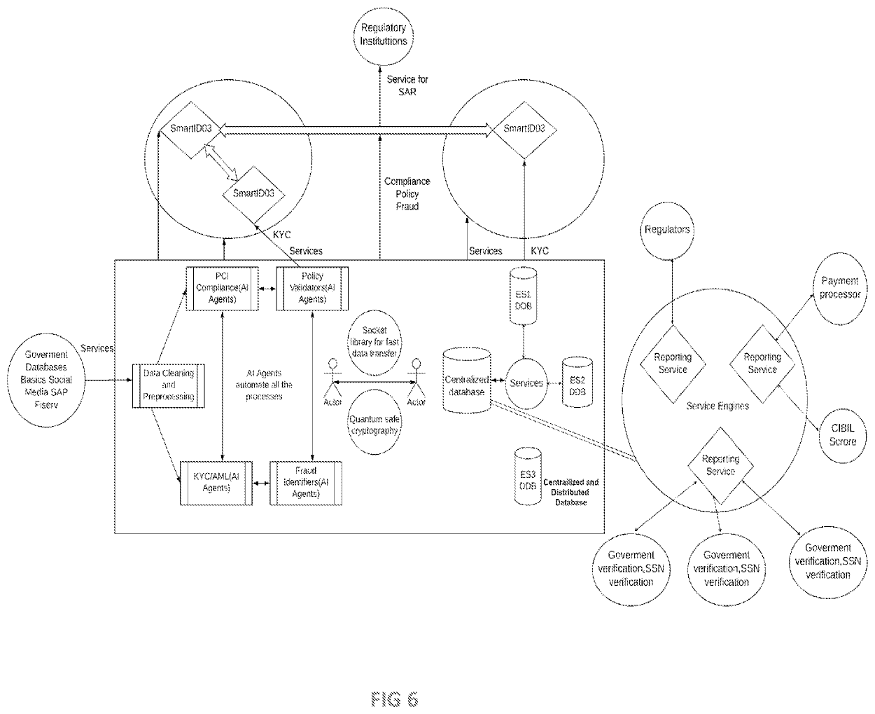

Referring to FIG. 6, there is seen an exemplary core technology of the invention according to one embodiment. In one embodiment, the invention is directed to a core technology that is a dynamic and fluid distributed system that deals with hyperconnected ecosystem, such as a mesh network. Different AI agents can make networks fully autonomous of processes and tasks. The transaction speed can be very fast and has the potential to reach more than one million transactions per second and the system can be dynamic enough to incorporate any old, existing, or new infrastructure. The system can be a hybrid of centralized and decentralized systems. Preferably, the quantum cryptography for data encryption is used.

In one embodiment, the invention can be used in a financial use case on top of a core technology for payments and banking services. In this embodiment, a Smartchain ID (“SmartID”) can be created for every user; a KYC (know your customer) can be performed; and a strength rating can be provided to every SmartID. AI Agents can automate the entire process. After the KYC is performed, a user can transfer money to any other user and AI agents for regulations and compliance can monitor transactions.

In a preferred embodiment, a service application of the invention has the following features:

(1) an API (application programming interface) to receive user data from banks;

(2) a module to clean the data;

(3) a module to preprocess the data;

(4) cryptographic encryption to create SmartID for end users;

(5) storing data in centralized database (Smartchain ID and KYC rating);

(6) callback hook to send Smartchain ID back to banks;

(7) API to get KYC data of a user from bank;

(8) cleaning data using a data cleaning module;

(9) preprocessing the data using a preprocessing module;

(10) an API to get data from government databases;

(11) an API to get data from social media;

(12) an API to get data from 3rd party sources such as SAP or Fiserv;

(13) cleaning data using the data cleaning module;

(14) preprocessing the data using the preprocessing module;

(15) storing user related data in a distributed database;

(16) an API to get a Smartchain ID strength rating;

(17) an API to get the Smartchain ID financial rating;

(18) a socket library implemented to use data transfer protocol;

(19) a module (Machine Learning (ML) models) to check regulations and policies for data communication;

(20) a module (ML models) for real time fraud detection;

(21) a module (ML models) for Anti-Money Laundering (payments);

(22) an API to send a report to regulatory institutes;

(23) a Quantum resistant cryptography to encrypt data;

(24) sending data to the high speed network using, e.g., a Python socket library;

(25) decrypting data at the receivers end; and

(26) updating transactional details at both senders and receivers end.

In one embodiment, an API can be used to get user data from CSV. If banks or any organization has preexisting data, then an embodiment of the invention can have a tool to migrate and integrate the preexisting data with SmartID to get SmartIDs for existing users or new SmartIDs for first time users; and thus there is no need for users to re-register all over again.

In one embodiment, to migrate banking user IDs and information into SmartID, the invention can provide a process that is seamless without a banking customer ever knowing that the banks were upgraded to the system. Even their normal passwords get transitioned, but they get prompted to recreate brand new passwords after that.

Also any documentation, such as social security numbers (SSN) or passports, can be stored in either organizations' servers and/or users' devices if they desire data curation. Preferably, APIs can fetch these documentations if an ecosystem or a user requests those documents from another ecosystem; and each ecosystem can contain their own customer's document for them. NLP (Natural Language Processing servicing can be implemented for deep diving in user's global presence. For example, a software toolkit “jiant” can be used to make the NLP strong. (See jiant, available at https://jiant.info/.)

The invention can have a module to clean the data, which can be part of a distributed node of each ecosystem and can be entertained by their AI agents.

The invention can have a module to preprocess the data.

The invention can perform cryptographic encryption to create SmartIDs for end users.

The invention can store data in a centralized database (e.g., SmartID and KYC rating). There can be a common channel for SmartIDs, as all of the data is not stored. However, at least data is required in the common and centralized channel. Once different users are part of each ecosystem, data related to the users can be removed from the centralized storage and can be stored at a node for only those users who are part of the same ecosystem unless the invention needs to fetch certain data which can be retrieved from other ecosystems.

The invention can have an API to get KYC data of a user from a bank.

The invention can perform SmartID asset tracking and transaction tracking.

The invention can clean data using a data cleaning module.

The invention can preprocess the data using a preprocessing module.

The invention can have an API to get data from government databases.

The invention can have an API to get data from social media also to be crawling the Internet to see any other online presences. In one embodiment, a trusted API of government Institutes could collaborate with AI agents.

The invention can have an API to get data from and send data to third party sources such as SAP, Fiserv, and Actimize. This data can be structured data.

The invention can clean data using the data cleaning module.

The invention can preprocess the data using the preprocessing module.

In another embodiment, tracking and keeping record of digital signature and transactions can be implemented at the invention's distributed nodes.

The invention can store user-related data in a distributed node database. All data can be linked in a graph database, such as ArangoDB, Hypergraph and grakn.ai, or other types of databases.

The invention can have an API to get the Smartchain ID (SID) strength rating (e.g., risk, behavior, trends, etc.).

The invention can have an API to get the SID financial rating (e.g., credit risk, default risk, fraud risk, behavior, trends, etc.).

KYC can have two or three types of rating. For example, type 1 can be to know the person is a real person; type 2 can be a credit risk; and type 3 can be a financial risk unless 2 and 3 are the same.

The invention can have a socket library to user data transfer protocols to allow users to send data over the network.

The invention can perform data mapping and discovery to make it easy for auditors to know what has happened, what the AI has done, and what the users have done.

The invention can have a module (e.g., ML models) to check regulations and policies for data communication. An AI agent can take action when a certain type of transaction takes place to ensure if it goes through or not.

The invention can have a module (e.g., ML models) for real time fraud detection.

The invention can have a module (e.g., ML models) for Anti-Money Laundering (Payments).

The invention can have an API to send reports to Regulatory institutes and possibly any government agencies or institutes. An AI agent using NLP to write up reports a typical compliance officer would normally write. Types of reports can be SARS, anything similar to SARS that is used in other countries, plus any other reports bankers will need.

The invention can utilize real-world contracts to make them into smart contract templates (e.g., standards purchase orders, ISDA (international swaps and derivatives association) master agreement, industry standard documents, etc.) also dealing with optical character recognition and contract management cycle.

The invention can use AI and NLP to allow non-technical people to readily write legal contracts. NLP services can take place to design their templates based on the behavior of the contract.

The invention can have a logic on who gets the data. For example in a financial use case, when a user sends payments, the backend copy of that data not only goes to banks but also to government organizations, regulatory agencies, etc. This data can be transferred from node to node, and a signal can be sent to the central service, which implies this information on another Service engine (e.g., Regulator Distributor). This engine can send the copies in background to the government organizations and regulatory agencies in line with the SLA”.

The invention can encrypt data using quantum resistant cryptography.

Data can be sent to the high speed network using for example a Python socket library. Sockets can be the packages of the fast data transfer in tunnels. These are self-identifiers, where the proxies of the invention can be implemented.

Data can be decrypted at the receiver's end.

Transactional details can be updated at both sender's and receiver's ends. The financial transactions can be settled and updated on the preexisting banking ledger systems that banks use.

The invention can reverse and/or alter transactions depending on the situation. The invention can send updates to all the associated ledger parties of those changes.

Third party developers can build whatever they want and whatever use case on the invention, so the core technology can be considered as an infrastructure as a service, a platform as a service, and a software as a service. The invention can have limitations so if users try to build more than a certain number of nodes or anything unanticipated then users would need to pay for the enterprise level. The invention can have open source APIs within the core technology. These APIs can be JSON (JavaScript Object Notation) formatted, so that any developer could integrate the invention within their ecosystem.

For a financial use case, users can link all their data in their ecosystem. The users have an option to then build their own AI agents and/or DAAPS within the ecosystem (e.g., the benefit is that they can optimize their financials).

The invention can perform cash flow optimizations. The ecosystem and a multilateral netting technology together can enable users to use machine learning techniques to optimize cash flow for businesses. These optimizations include, but are not limited to, the following: a maximization/minimization of invoice discount/penalties; payment plans with a FX Prediction (Foreign Exchange Prediction) feature, which can bring down FX conversion fees; a payment plan prediction with user behavior analysis; and a minimization of tax fees.

The invention can provide an option to a user to analyze a company's book to produce a rating of how healthy a company is, using various deep machine learning techniques in the accounting and finance space.

The invention can have an AI agent to clean the structured and unstructured data as more than 60% of the time can be given to clean the data. The AI agent can make the necessary changes to for example the columns which need to be converted from numeric to factor or vice versa or tagging the images audio, video and text. The invention can check the discrepancies in data to take care of all the missing values and outliers. The invention can perform mapping and structuring all types of data, and perform training itself for example by taking small data and when it gets larger data sets it performs training with.

The invention can manage and monitor all the ecosystems with SmartID. Also the users can manage and monitor their ecosystems with SmartID. In one embodiment, tools for migrating the ecosystems' existing user base and any other information into a SmartID system are provided. The users will not know the difference. For example, users can login as normal and then the system can be configured to inform that the users have a SmartID and confirm identity to merge.

For migrating existing users, the invention can get data of all the users of an organization and create SmartIDs for them and then return the SmartIDs to the respective organization, e.g. a bank. Then, the bank can provide newly created SmartIDs to their users.

The invention can increase the speed of the transactions since the invention has its own protocol. In some embodiments, the invention can avoid the need for a TLS/SSL (Transport Layer Security/Secure Sockets Layer). The invention can prevent downgrade attacks. One of TLS 1.3 issues is that it makes it impossible for banks to decrypt and monitor TLS connections traffic. The invention can solve this since in its ecosystem it can monitor those connections. Another issue is that TLS 1.3 uses 0-RTT (Zero Round Trip Time) resumption. The invention can have the resumption key being shuffled and changed so it would be difficult for hackers to get access and spoof connections. The invention can have security on all layers.

The invention will use QUIC protocol to increase the speed of the transaction, and use post-quantum encryption to enhance security. The connection will be optimized by a network optimizer that comprises one or more AI agents.

The invention can secure API connections and prevent vulnerable APIs from accessing. The invention can manage all the services and APIs.

The invention can have an AI agent that cleans, trains, and classifies data. It also uses advanced techniques where labeling of training data for any AI model need not be created by a user but can be done programmatically by extracting relationships between entities. In other words, an AI agent can analyze, extract, and clean data. It can be used to extract data from different ecosystems. Smartchain can use different programming functions like labelling functions, transforming functions and slicing functions on data.

The invention can perform data mapping and discovery.

The invention can have a combination of shuffling keys with quantum resistance security, allowing the system to be dynamic and fluid. This can constantly change and shuffle public/private keys (e.g., homomorphic) without sacrificing speed.

The invention can also be utilized on a hardware level. For example, the invention can be embedded in autonomous cars or in mobile phone hardware.

The invention can utilize Spiffe to readily manage certifications. See Spiffe, available at https://spiffe.io.

The invention can have multiple layers, multi hierarchical, parent-child relationship between layers/pipelines. When it comes to financial transactions that should be adhered to universal rules of the hyperconnected ecosystem and yet when banks have their own use cases (e.g., some type of data transfer), they can have their own set of rules/policies. In the hyperconnected ecosystem, multiple systems, databases, ecosystems can be all converged or connected into one. Thus, the invention can be flexible and also can adhere to GDPR (General Data Protection Regulation) and government regulations to make sure everything is legitimate.

The invention can use containers and virtual machines. To avoid data overload on the central global servers, AI agents can improve and optimize overall infrastructure, rendering the invention faster and lighter-weight through optimization of code, core of AI operations, autonomously improving network paths, and auto scaling components parts of infrastructure to handle load.

Smartchain can use a combination of AI techniques such as Intelligence amplification (Distributed cognition), Swann Intelligence (collaborative AI), Genetic Algorithm, Evolutionary Algorithm, Evolutionary Strategies, Spatial and behavior intelligence, Genetic Programming, Cartesian Genetic Programming, Covariance Matrix Adaptation Evolution Strategy, Deep meta learning, and Explainable AI, intelligent data, Lifelong Learning with Dynamically Expandable Networks, Human collaboration, autoML, etc.

AI models of the invention can use deep neural networks and can incorporate other technologies.

The invention can use an explainable AI, which explains what is being done, unlike blackbox, which does not explain how the system comes to a solution. Explainable AI comes with a tradeoff between accuracy and explainability. The invention can use an AI that uses complex neural networks. The invention can choose between the two methods used for explainability of neural networks namely Ante-Hoc and Post-Hoc. Ante-Hoc methods contain techniques, such as RETAIN (Reversed Time Attention Model) and BDL (Bayesian Deep Learning). Post-Hoc methods contain techniques, such as LIME (Local Interpretable Model-agnostic Explanations) and LRP (layer-wise Relevance Propagation).

The invention can have an AI agent that cleans the structured and unstructured data. The AI agent can make changes to the columns which need to be converted from numeric to factor or vice versa or tagging the images audio, video, and text. The AI agent can check the discrepancies in data to take care of all the missing values and outliers.

The invention can be configured to convert unstructured data, label data, and transform data.

The invention can use distributed training of AI models.

The invention can handle all types of data sources, databases and any type of data qualitative, quantitative, attribute, discrete, continuous data, noir, big data, structured, unstructured, semi-structured data, time-stamped data, machine data, spatiotemporal data, open data, dark data, real time data, genomic data, operational data, linked data, high-dimensional data, unverified outdated data, Translytic data, fast data, lost data, Symbolic data, etc. This can be achieved because the AI agents are configured to take in different types of data, cleans and preprocesses the data.

The invention can provide an option for data exchange, whereby devices or people can determine which data to give free or to sell. This can be achieved by using collaborative AI since it can formulate, combine, and create new types of data from the preexisting data of other sources (meaning that data scientists can cross-sell their data with other data scientists).

The invention can provide a financial ecosystem dealing in a suite of financial remittance, regulation and compliance (internal and external usage), AML (anti-money laundering), and KYC (know your customer). This is not only good for money remittance but also for financial securities since it takes about three business days to complete a transaction while the invention can complete a transaction in a few seconds. In addition, the invention can allow developers to build DAAPS (Data as a platform) and/or AI agents for their organization to do whatever they need to do since all the data is being streamlined and organized so if they want to do account optimization, portfolio management, insurance, or whatever their imagination is, the invention can make it possible.

Within that financial ecosystem of the invention, there can be an ecosystem within it for each of the financial organizations and their own internal purpose and by region. This allows banks and financial institutions to transition into Smartchain® with ease.

The invention can have an AI agent that automates every signal process in compliance with anti-money laundering requirements and the Bank Secrecy Act. The invention can be configured to perform in compliance with rules for different types of transactions such as remittance (actual money), financial instruments (stocks, bonds, invoices, etc.), and crypto currencies.

The invention can have different dashboards, for example, (1) for the global central server to see all the KPI (Key Performance Indicator), metrics, visuals of the ecosystems and nodes, to also provide permission for certain people, for example, operators of the invention; and (2) for the banks from controlling their ecosystems and sub ecosystems to provide permissions. There are different types of people in a bank, such as the compliance office, KYC person, and other types of people. The invention is tailored to each of those specific types of people.

The invention can utilize the ACH (Analysis of Competing Hypotheses) to detect financial climes, behavior of a person to determine risk, KYC, etc. See The ACH Methodology and Its Purpose, available at http://competinghypotheses.org/docs/The_ACH_Methodology_and_Its_Purpose, the content of which is incorporated herein by reference. The invention can utilize the Open Synthesis to make the analysis stronger especially for vast data. See Open Synthesis, available at https://github.com/twschiller/open-synthesis, the content of which is incorporated herein by reference.

The invention can utilize the Control Flow Integrity to prevent memory corruption. See Control Flow Integrity, available at https://github.com/nsacyber/Control-Flow-Integrity, the content of which is incorporated herein by reference.

The invention can utilize cloud nodes that allow users to avoid downloading additional software when the users have a mobile banking app and that bank is on the invention.

The protocol of the invention is planned to be a flexible protocol primarily based on policies run by AI. Each individual ecosystem may have customized protocols which ranging from consensus models, network architectures, web services, etc., as per the application. This flexibility is possible with the use of specialized AI agents.

The invention can use and manage SmartIDs. This tool is similar to Google® or Facebook® login where people can access using the same credentials, basically a single sign on. This is robust, as users have control of their own data to give permission to those who can access it, and a universal wallet to hold multiple cryptocurrencies and records. One of the differences between single sign on and SmartID is profile driven. Also SmartID is more than creating accounts with emails and passwords; it is a profile of both online and offline presence. The system will be able to verify if they are real and/or legitimate persons based on whether they have offline/online presence, tracking interactions to determine a behavior risk, especially credit scores, etc. In a preferred embodiment, a user can only create one SmartID account not multiple, but the user can create multiple sub-accounts including aliases, which are linked to a real person. In one embodiment, SmartID is a password manager. Since users have control of data, they can share access with limitations (e.g., giving someone access to manage the user's twitter account and then can easily remove that access later).

Based on how people will program on the invention, if it deals with building an identity profile, it should be all synced together. For example, if a program on the invention is for job assessment of whether a person is qualified to do a certain work, data can be shared with other companies to decide to hire or not based on qualifications from other companies and not just on resume. For companies and financial institutes, it should be a great way to fully audit a person as well.

A person's identity can be all interconnected. If the person has offshore accounts, subsidiaries, alias, etc., connections that will link to those identities can be formed. This will be advantageous in tracking information on bank accounts, missing information on credit information, etc.

With SmartID, it is possible to share access without giving passwords. For example, a first user can give another access to the first user's bank account and then terminate that access; when an assistant is needing access to a user's twitter account or email, the user can give access to the assistant without giving a password.

Every account can be controlled by any weighted combination of other accounts and private keys. This creates a hierarchical structure that reflects how permissions are organized in real life, and makes multi-user control over funds easier than ever. Multi-user control is the single biggest contributor to security, and, when used properly, it can virtually eliminate the risk of theft due to hacking.

Each user's SmartID undergoes various evaluations to ensure the legitimacy of identities. It takes advantage of various API integrations with other information sources, such as government databases, banks, and social media accounts to verify identities. The completeness and correctness of all information connected to the SmartID is evaluated using the Smartchain ID (SID) strength rating. This feature can be fully autonomous since it creates a public/private profile. A high SID strength rating signifies that risk profiling done on the user has a high reliability/confidence rating.

SmartID is not just for individual users but also for companies as well. Users can be linked to a company to basically claim as employee, owner, or administrator, etc., with set permissions.

SmartID can also be protected under an additional layer of biometrics security. Biometrics security is the measurement and statistical analysis of unique physical and behavioral characteristics for identification, verification, and access control for a user. Some examples of biometric identifiers are fingerprints, facial features, iris, and palm patterns. Hence the biometrics security layer protecting SmartID can itself have multiple layers i.e. different combinations of the above-discussed identifiers for different levels of authentication. This invention not only pertains to biometric identifiers such as fingerprint, iris, face, and palm but also to voice, unique behavioral and emotional patterns shown by human beings under certain conditions. Biometrics security coupled with SmartID can be a powerful tool in the hands of the user, revolutionizing the way transaction/purchase happens in the customer-to-business (B2C) as well as customer-to-customer (C2C) model. Ex. users would be able to make purchases at retail stores even without their credit cards or wallets, as they can authenticate themselves using their biometrics and pay using their credit card information stored in the SmartID.

To avoid the negative effects of anonymity that characterize some Blockchain applications (e.g., Bitcoin®), the invention leverages real-time network relationships among users and high-trust institutions. Each user will be vetted by high-trust institutions and/or their peers to verify the stated identity, for example, by checking both online and offline profiles of a person in government databases, watchlist, social media, etc. This is key to preventing multiple fake identities that would jeopardize the integrity of the ecosystem. This grounds the invention to reality that cooperation with the government and other existing institutions, as well as explicit and implicit social relationships, is a fundamental requirement.

The invention can comprise a know your customer (KYC) AI module that continually predicts each user's risk profiles for different use cases (e.g., credit risk, default risk, fraud risk, etc.). Risk prediction for each user happens at different times in the user's Smartchain® lifecycle. This allows user A to make smart decisions on whether they should transact with user B by considering user B's risk profiles and reliability based on the SID strength rating, and vice versa.

Many of the current digital enterprise identity management services are missing the fact that companies are basically groups of people. Using the computing power available in the invention, the KYC AI module factors in individual employee's own risk profiles and SID Strength Ratings.

Using the Identity Management capabilities of the invention, the user's SmartID can replace their numerous offline identification documents. The invention Smartchain stores the various digitized documents in a gallery that the user can filter depending on the use case. There is no need to manually look and collate documents. Everything is ready based on predefined and customized filters that can fit every situation. SmartID can replace even social security numbers for governments globally.

With the present invention, each user has their own unhackable identity which matches their real-world identity. Users can sign in with their own SmartID key, which is paired with their real-world offline identification documents and records. The SmartID is vetted and verified by high-trust institutions, such as government agencies and banks, as well as by peers (the different levels of verification are visible to other users). For example, an institution looks at both online and offline data, and with each organization that has more than one commonality, it checks whether information is true. Government identity, banking identities, medical records, or even resumes can be secured onto the SmartID. Communication for transactions becomes secure and decentralized, without the “middle-man.” Know-Your-Customer (KYC) is seamlessly interwoven into each user's lifecycle.

The SmartID can act as the main point of contact for any possible use case, through deeply rooted partnerships with different governments and institutions. Once the connection between the institution and a system of the invention has been made, the user can opt to share permissions only for the documents that are required for a particular use case, using the document curation feature. This is perfect for GDPR and something banks and other organizations could hopefully digest into.

In an embodiment where the invention is implemented using software, the software may be stored in a computer program product and loaded into a computer system using removable storage drive, hard drive or communications interface. The control logic (software), when executed by the processor, causes the processor to perform the functions of the invention as described herein. Various programming languages including Python® can be used.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

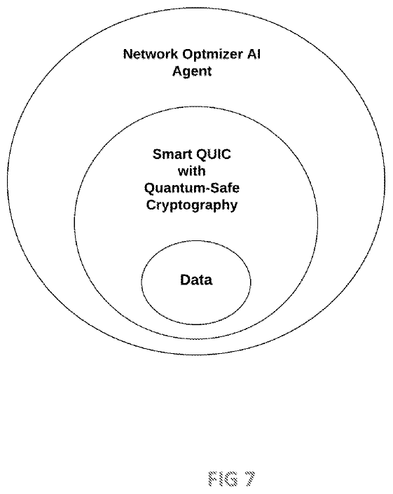

Referring to FIG. 7, there is a diagram of data transfer communication. Data will be transferred using QUIC that uses UDP to transfer data packets. The transfer will be secured through a secure tunnel (Smart VPN) which is a quantum-safe encrypted link between origin and destination. Post quantum cryptography comprises quantum resistant algorithms (QRA) that creates valuable math problems to avoid quantum computers to attack data communication.

Each distributed ecosystem will be using this kind of secured communication.

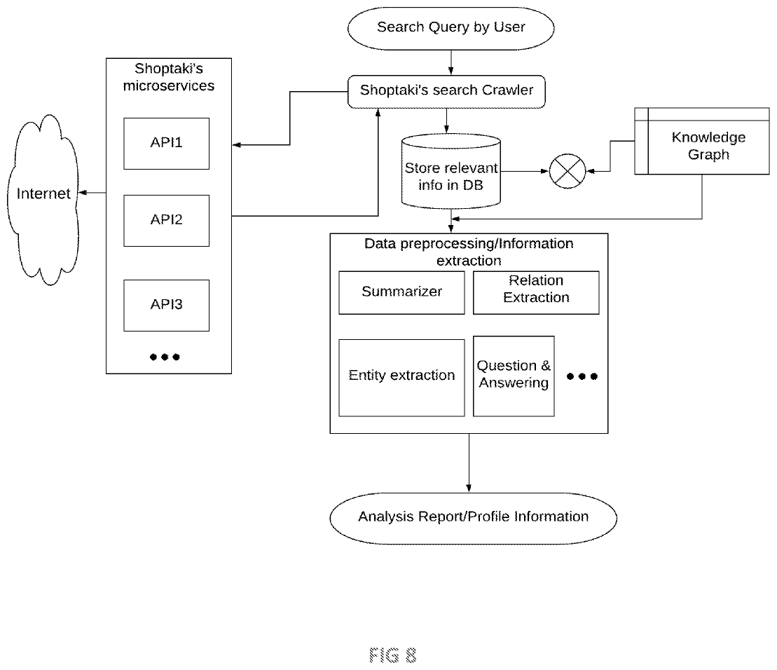

Referring to FIG. 8, represents the architecture of the Smartdive tool on the Smartchain network. The Smartdive tool can verify an individual's identity with a high degree of confidence. The tool amasses an extensive collection of data gathered through various means such as social media platforms, publicly available data like articles, data available within and outside the organization. Once all of this data is extracted, it is processed, cleaned, and accessed for accuracy and integrity. Once a high level of confidence is reached, the data is summarized and questions are generated so interested parties have the option of viewing all data pertaining to an individual or only certain information that is applicable in a certain situation. Depending on the wealth of information supplied, the ability to have this choice may be critical and expedient.

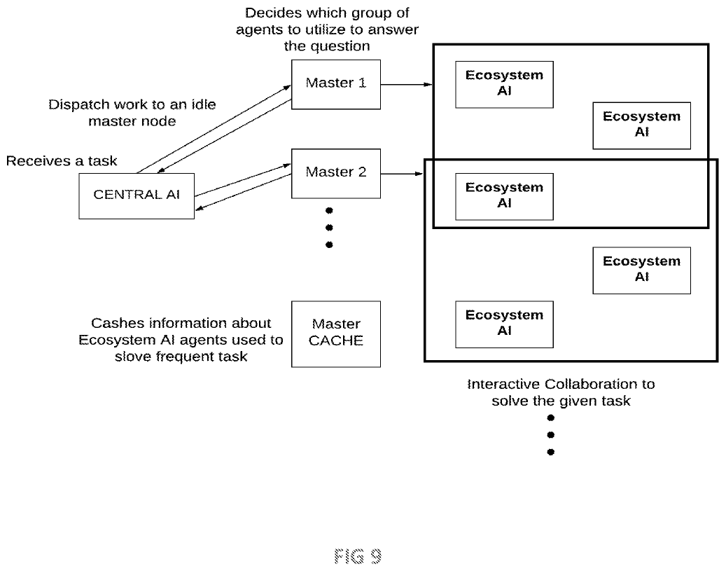

Referring to FIG. 9, is a general representation of collaborative AI agents system, consisting of Central AI, Master AI, Master Cache and several AI-based Ecosystems. This diagram represents how our hyperconnected network will be utilized by our AIs to fulfill their tasks. AI agents will be acting as nodes which create the hyperconnected network. This diagram, thus, represents how the AI agents will interact with each other, over the network to complete their tasks. There will be a Central AI, which will be the core center of our hyperconnected network system, under which the Master AI and Master Cache will function. The next in the hierarchy is Ecosystem AIs which are a cluster of many AI agents, used to perform a particular task. There are thus, many groups of Ecosystem AIs allotted for different tasks. Performing the actual task is done by AI agents in the selected Ecosystem AI group. The Ecosystem AI group to be selected for a given particular task is decided by the Master AIs. Master AI take this decision on the basis of the information stored in Master Cache. Master Cache stores the information regarding which Ecosystem AI group was used for a particular task. Thus, the successful interaction between Master AIs and Master Cache results in proper decision making and leads to fast execution of a task. The Central AI is the core part of the Collaborative AI agent system, as it delegates task and decision making roles to Master AIs for further execution process. It constantly receives task requests if present, and accordingly dispatches the decision making role to the Master AI which is in idle mode at that given time. Until the Central AI delegates further responsibilities and tasks to the chosen Master AI, the system can never perform the task successfully. Thus, proper functioning of Central AI is essential and integral for our system's proper functioning.

The Title, Background, Summary, Brief Description of the Drawings and Abstract of the disclosure are hereby incorporated into the disclosure and are provided as illustrative examples of the disclosure, not as restrictive descriptions. The following claims are hereby incorporated into the Detailed Description, with each claim standing on its own as a separately claimed subject matter. The claims are not intended to be limited to the aspects described herein, but is to be accorded the full scope consistent with the language claims and to encompass all legal equivalents. Notwithstanding, none of the claims are intended to embrace subject matter that fails to satisfy the requirement of 35 U.S.C. § 101, 102, or 103, nor should they be interpreted in such a way.

1. A Hyper connected network for passing information between users comprising inter connected nodes and central server using AI to delegate tasks to master AIs associated with said nodes wherein said master AIs direct packets of information associated with smart IDs to correct destinations within the network wherein the smart ID includes relevant and valid data belonging to each individual using the network, and wherein the AI associated with a node strips the smart ID of any information that is not relevant to its destination.

2. The hyper connected network of claim 1, wherein the hyper-connected network comprises sub-networks comprising interconnected nodes.

3. The hyper connected network of claim 2, wherein said sub-networks form distinct platforms or systems.

4. The hyper connected network of claim 1, wherein said smart ID includes biometric data associated with the user.

5. The hyper connected network of claim 1, wherein information passing between nodes is subjected to review by a quantum resistant algorithm.

6. The hyper connected network of claim 1, wherein transfer of information between nodes is through a secure tunnel with quantum-safe encryption which provides an encrypted link between the host of the information and its destination.

7. The hyper connected network of claim 1, wherein the user can tell the SmartID what information can be accessed based on a system from which a request originates by providing rights to that specific system to access the data through said SmartID.

8. The hyper connected network of claim 1, wherein separate AI agents are tasked with tasks selected from optimizing the infrastructure, cleaning data, and making specific information data available based on the origin of a request for such information.

9. The hyper connected network of claim 1, wherein AI agents check whether information being supplied is being used for legal purposes.

10. The hyper connected network of claim 1, wherein information to be passed through the network is aggregated into packets from more than one hosts and associated with a Smart ID before being transmitted through the network.

11. The hyper connected network of claim 10, wherein said packets are configured to route themselves through the network based on goals assigned to them before entering the network and to pursue these goals adaptively

12. The hyper connected network of claim 1, in the form of a distributed data management system, comprising: a central global server; wherein the central global server comprises a central network and a plurality of distributed nodes, wherein the central global server can communicate with a plurality of ecosystems, wherein the central network is configured to store information of transactions between the plurality of ecosystems and the central global server, wherein each of the plurality of distributed nodes comprises: a plurality of artificial intelligence agents (AI agents), a transaction engine, a network connector for peer-to-peer, and a graphics database, wherein each of the plurality of distributed nodes directly or indirectly communicates with the central network.

13. The hyper connected network of claim 1, wherein a plurality of AI agents comprises at least one of a network optimizer (such as load balancer or routing optimizer), a financial risk analyzer, a fraud detector, a social presence validator, a non-social presence validator, an all compliance executor, a transaction behavior predictor, a structured data analyst, and an unstructured data analyst

14. The hyper connected network of claim 1, wherein at least one of the plurality of distributed nodes is configured to communicate with an ecosystem and to handshake with a new ecosystem.

15. The hyper connected network of claim 1, wherein the plurality of distributed nodes are configured to directly communicate with each other.

16. The hyper connected network of claim 1, which is in the form of a hybrid of the distributed and decentralized networks within a mesh network, where each node can be treated as a master node when that node distributes the data information in a private mesh network.

17. The hyper connected network of claim 1, is configured to permit sub networks to make transactions to each other, where each transaction can be analyzed by automated applied programming interfaces of AI agents on nodes in the networkd. The hyper connected network of claim 1, wherein whenever a transaction occurs, each relevant node connected into the network is updated with that transaction and a ledger will be maintained on each node.

19. The hyper connected network of claim 1, comprising one or more master nodes and one or more secondary nodes, wherein the master nodes linked to an entire ecosystem and has rules of the AI agents and other policies, and wherein the secondary nodes can be configured to perform non-vital actions based on use cases.

20. The hyper connected network of claim 1, wherein at least one node comprises a transaction engine to parse structured/unstructured data into a graph database or other appropriate database.

21. The hyper connected network of claim 1 which comprises:
an API (application programming interface) to receive user data from banks;
a module to clean the data;
a module to preprocess the data;
cryptographic encryption to create SmartID for end users;
storing data in centralized database (Smartchain ID and KYC rating);
callback hook to send Smartchain ID back to banks;
API to get KYC data of a user from bank;
Cleaning data using a data cleaning module;
preprocessing the data using a preprocessing module;
an API to get data from government databases;
an API to get data from social media;
an API to get data from 3rd party sources such as SAP or Fiserv;
cleaning data using the data cleaning module;
preprocessing the data using the preprocessing module;
storing user related data in a distributed database;
an API to get a Smartchain ID strength rating;
an API to get the Smartchain ID financial rating;
a socket library implemented to use data transfer protocol;
a module (Machine Learning (ML) models) to check regulations and policies for data communication;
a module (ML models) for real time fraud detection;
a module (ML models) for Anti-Money Laundering (payments);
an API to send a report to regulatory institutes;
a Quantum resistant cryptography to encrypt data;
whereby data is passed through a high speed network using, e.g., a Python socket library;
data is decrypted at the receivers end; and
transactional details updated at both senders and receivers ends.

22. A. A method for passing information between users, using a Hyper connected network comprising inter connected nodes and a central server, the method comprising:
delegating, by the central server using AI, tasks to master AIs associated with said nodes, and
directing, by said master AIs, packets of information associated with smart IDs to correct destinations within the network,
wherein the smart ID includes relevant and valid data belonging to each individual using the network, and
wherein the AI associated with a node strips the smart ID of any information that is not relevant to its destination.
